(19) United States
(12) Patent Application Publication
(10) Pub. No.: US 2006/0194098 A1
(43) Pub. Date: Aug. 31, 2006

(54) Manufacturing method of flexible substrate laminate integrated fuel cell and fuel cell thereof

(75) Inventors: Tsang-Ming Chang, Taipei (TW); Hsi-Ming Shu, Taipei (TW); Feng-Yi Deng, Taipei (TW); Ching-Tang Chan, Taipei (TW); Yean-Der Kuan, Taipei (TW)

Correspondence Address: G. LINK Co., LTD, 3550 Bell Road, MINOOKA, IL, 60447, US

(73) Assignee: ANTIG TECHNOLOGY Co,Ltd.

(21) Appl. No.: 11/067,004

(22) Filed: Feb. 28, 2005

(51) Int. Cl. H01M 8/10; H01M 8/02; B31B 1/60; B32B 37/00

(52) U.S. Cl. 429/127; 429/30; 429/38; 156/60; 156/298

(57) ABSTRACT

The present invention is related to a manufacturing method of flexible substrate laminate integrated fuel cell, comprising step (A) to step (E). Step (A) is to utilize the flexible circuit substrate used in the printed circuit board (PCB) to respectively manufacture the anode current collection layer and cathode current collection layer by the PCB process. Step (B) is to manufacture a membrane electrode assembly layer. Step (C) is to utilize the lamination or bonding process to respectively laminate the anode current collection layer, membrane electrode assembly layer and cathode current collection layer into the fuel cell reactive layer. Step (D) is to utilize the flexible substrate to manufacture the flow layer. Step (E) is to laminate the fuel cell reactive layer and flow layer.

### FIELD OF THE INVENTION

The present invention is related to a manufacturing method of fuel cell and the fuel cell thereof, especially to a manufacturing method utilizing the process of printed circuit board (PCB) for the flexible circuit substrate to manufacture the flexible substrate laminate integrated fuel cell and the flexible substrate laminate integrated fuel cell manufactured by the present invention.

### BACKGROUND OF THE PRIOR ART

Flexible printed circuit board (FPC) is made of insulate substrate, adhesive and cooper conductor, which is why it is called FPC. The features of FPC are that it is able to assemble in three-dimensions and freely place processed conductors for the fit to the equipment and also is flexible, light and thin which is not achieved by the general hard laminate board. The current FPC is mainly used for the substitution of wire.

The conventional design of fuel cell is a stack design, this typical design has been disclosed in American Patents U.S. Pat. No. 5,200,278, U.S. Pat. No. 5,252,410, U.S. Pat. No. 5,360,679 and U.S. Pat. No. 6,030,718. Although these patents utilizing the prior art have higher producing efficiency of electricity, their composition is too complicated to be manufactured, and the cost is also very high leading to increase the requirement for the peripherals of the system.

American Patent U.S. Pat. No. 5,631,099 of surface replica fuel cell disclosed a fuel cell of including stack and planar design, that is, U.S. Pat. No. 5,631,099 combines the merits of pile-up and co-planar design to increase the producing efficiency of electricity and also has the advantages of easy manufacture, low cost, light weight, convenient usage and less space limit. However, U.S. Pat. No. 5,631,099 also has the disadvantages of a complex structure, difficult manufacture, hard to exhaust the reactive product like the water, and hard to supply the air or oxygen.

The inventor investigates the disadvantages of the above used fuel cell and desires to improve and invent a PCB process technology of FPC to implement the manufacture of the fuel cell so as to possess the advantages of easy manufacture, low cost, light weight, convenient usage and less space limit.

### SUMMARY OF THE INVENTION

The main object of the present invention is to provide a manufacturing method of flexible substrate laminate integrated fuel cell which utilizes the PCB process technology of FPC and improves it for the manufacture of fuel cells.

Another object of the present invention is to provide a laminate integrated fuel cell in accordance with the light, thin, short, small features and flexibly to adjust the shape and size.

To achieve the above objects, the present invention provides a manufacturing method of flexible substrate laminate integrated fuel cell, comprising the following steps of utilizing the flexible circuit substrate used in the PCB to respectively manufacture the anode current collection layer and cathode current collection layer by the PCB process; manufacturing the membrane electrode assembly layer; utilizing the pressing or adhering process to respectively laminate the anode current collection layer, membrane electrode assembly layer and cathode current collection layer into the fuel cell reactive layer; utilizing the flexible substrate to manufacture the flow layer; laminating the fuel cell reactive layer and flow layer; and then completing the manufacture of flexible substrate laminate integrated fuel cell.

Furthermore, in order to achieve the above objects again, the present invention is to provide a flexible substrate laminate fuel cell, comprising: the anode and cathode current collection layer respectively manufactured by a FPC; the membrane electrode assembly layer sandwiched between the anode and cathode current collection layer; and finally connecting to the flow layer designed in accordance with the shape required in assembly to form a flexible substrate laminate integrated fuel cell.

### BRIEF DESCRIPTION OF THE DRAWINGS

The above objects and advantages of the present invention will become more apparent with reference to the appended drawings wherein:

FIG. 1 shows the flow diagram of the manufacturing method of the present invention flexible substrate laminate integrated fuel cell;

FIG. 2 shows the structural diagram of the anode current collection layer manufactured by the present invention;

FIG. 3 shows the magnified diagram of the structure of the anode current collection of the present invention;

FIG. 4 shows the structural diagram of the cathode current collection layer manufactured by the present invention;

FIG. 5 shows the magnified diagram of the structure of the cathode current collection of the present invention;

FIG. 6 shows the structural decomposition of the membrane electrode assembly layer;

FIG. 7 shows the structural diagram of the membrane electrode assembly layer manufactured by the present invention;

FIG. 8 shows the structural diagram of the fuel cell reactive layer manufactured by the present invention;

FIG. 9 shows the structural diagram of the flow layer manufactured by the present invention;

FIG. 10 shows the structural diagram of the flow layer in another different view manufactured by the present invention; and

FIG. 11 shows the structural diagram of the flexible substrate laminate integrated fuel cell manufactured by the present invention.

### DETAILED DESCRIPTION OF THE INVENTION

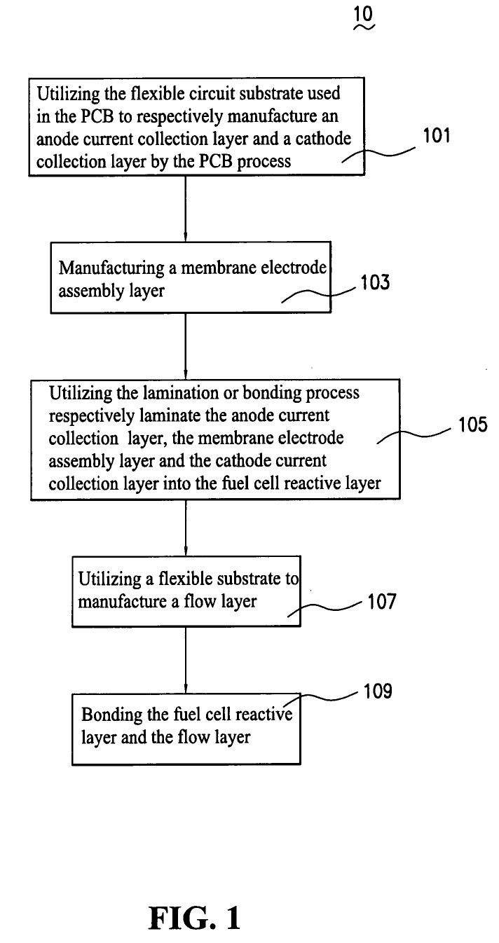

The present invention manufacturing method 10 is used to manufacture a flexible substrate laminate integrated fuel cell, especially to manufacture flexible substrate laminate integrated direct methanol fuel cell. The flowchart of the present invention manufacturing method 10 like FIG. 1 shows that most of the present invention manufacturing method 10 only utilizes the flexible circuit substrate of the PCB as the material like the flexible cooper foil substrate made of cooper and resin so as to obviously reveal the merits of easy manufacture and economic manufacturing cost and accord with the present product trend with respect to the used manufacturing method of fuel cell which uses higher cost of materials and has manufacturing difficulty. Meanwhile, the direct methanol fuel cell 20 produced by the present invention manufacturing method 10, which is easily manufactured as the fuel cell with the light, thin, short, small features and versatile appearance, excellently matches the power usage of versatile portable electronics like mobile phone, PDA, smart phone, e-book, tablet PC and notebook. The present invention manufacturing method 10 is easy to quickly manufacture the flexible substrate laminate integrated fuel cell 20 according to the conditions of appearance, size and power so as to provide the fuel cell a profoundly convenient manufacturing method.

According to the manufacturing method of flexible substrate laminate integrated direct methanol fuel cell referring to the flow diagram of the manufacturing method of the present invention flexible substrate laminate integrated fuel cell shown in FIG. 1, the manufacturing method 10 are respectively described step by step thereinafter. Step 101 is to use the flexible circuit substrate of PCB to respectively manufacture anode current collection layer 201 and cathode current collection layer 203 by utilizing the PCB process. The embodiment of the present invention step 101 is to use the flexible copper foil substrate in the PCB material as the example of the flexible circuit substrate, and in order to have a convenient interpretation and easy to understand the present invention just only to disclose how to manufacture the anode current collection layer 201 and similarly manufacture the cathode current collection layer 203 according to the manufacturing method of the anode current collection layer 201. The flexible copper foil substrate utilizes conventional drilling process of PCB and then the whole substrate a chemical copper layer with the thickness about 10 u to 50 u inches and again plates the copper with a thickness about 200 u to 500 u inches and therefore plates the gold with a thickness about 3 u to 10 u inches soon after the processes of film lamination, photo exposure and develop, and then bases on the placement condition of the anode current collection 201a to make each anode current collection 201a be able to correspond to the corresponding fuel cell unit 20a with respect to the membrane electrode assembly layer 205. Again, it also places the control circuit 201b which is mainly composed of plural SMT electronic devices. Finally, the copper patterns etched by the design of the anode current collection 201a and the control circuit 201b proceed the soldering of SMT electronic devices and the test of good/bad circuitry and therefore complete the anode current collection layer 201.

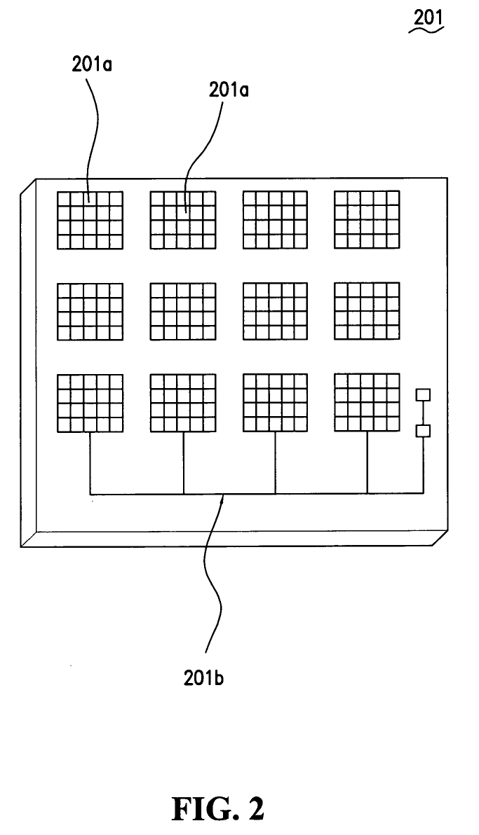

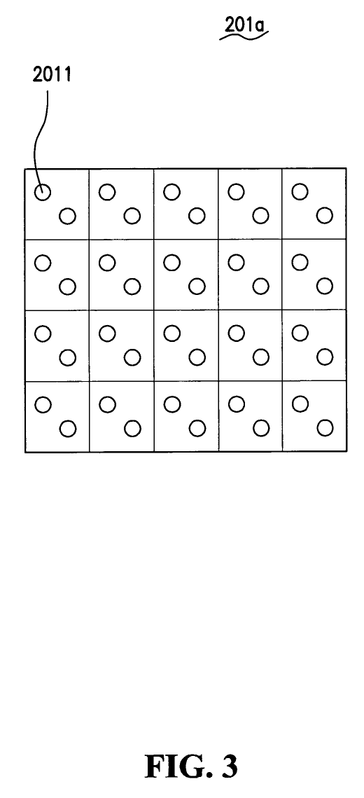

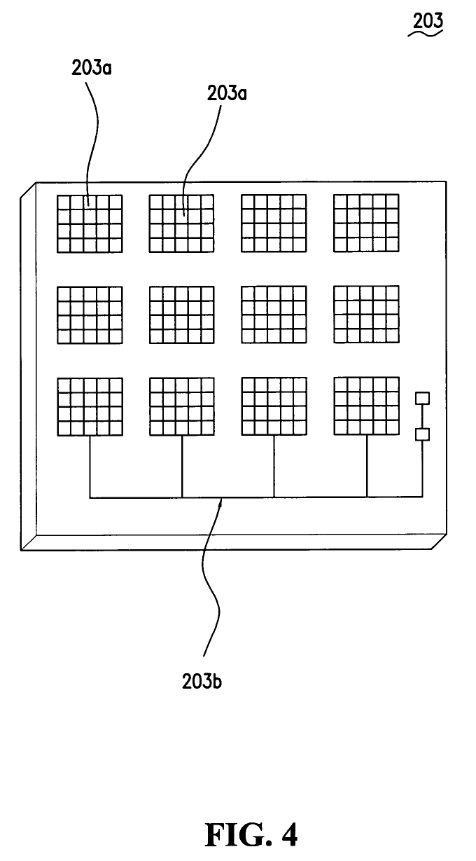

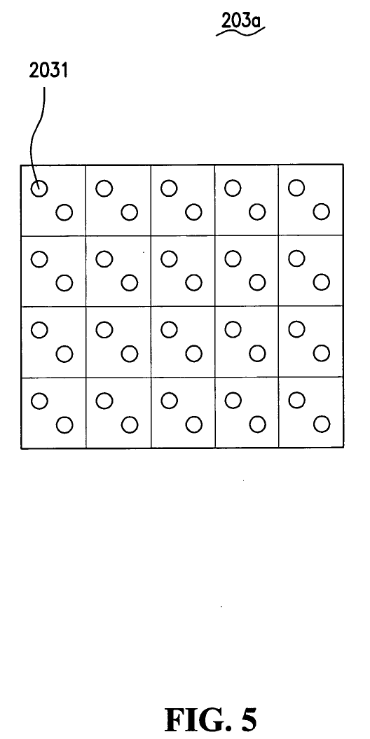

FIG. 2 shows the structural diagram of the anode current collection layer manufactured by the present invention, FIG. 3 shows the magnified diagram of the structure of the anode current collection of the present invention, FIG. 4 shows the structural diagram of the cathode current collection layer manufactured by the present invention and FIG. 5 shows the magnified diagram of the structure of the cathode current collection of the present invention. By way of the step 101 to manufacture the anode current collection layer 201 and cathode current collection layer 203 which have the anode current collection 201a and cathode current collection 203a respectively formed by the etched copper foil patterns, it also places many through-holes 2011 and 2031 within the area belonging to the anode current collection 201a and the cathode current collection 203a, and these holes 2011 within the anode current collection 201a are able to supply methanol solution flowing into the membrane electrode assembly layer 205 and also those holes 2031 within the cathode current collection 203a are able to supply external air flowing into the membrane electrode assembly layer 205. Furthermore, the control circuit 201b placed in the anode current collection layer 201 and the control circuit 203b placed in the cathode current collection layer 203 are able to enhance the feasibility of the fuel cell 20 by way of the function revealed by the control circuit 201b and 203b.

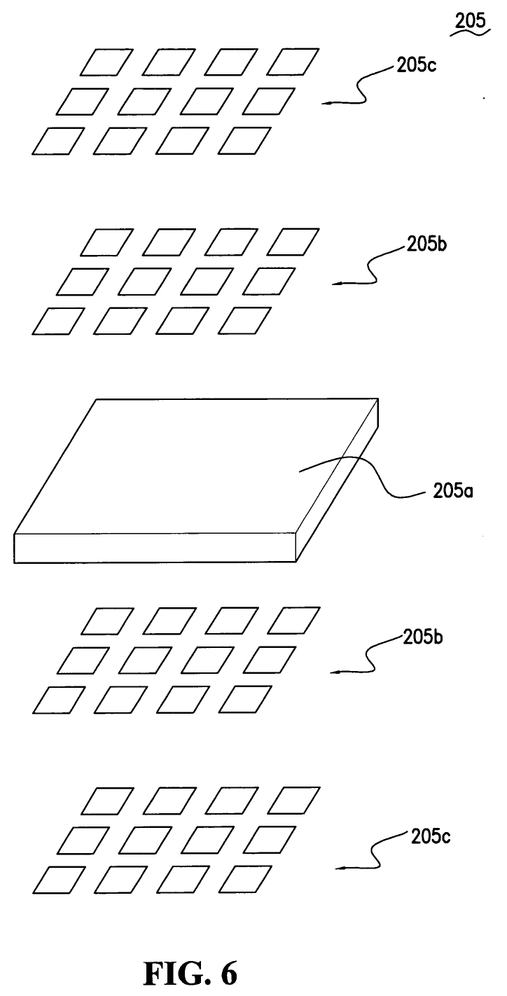

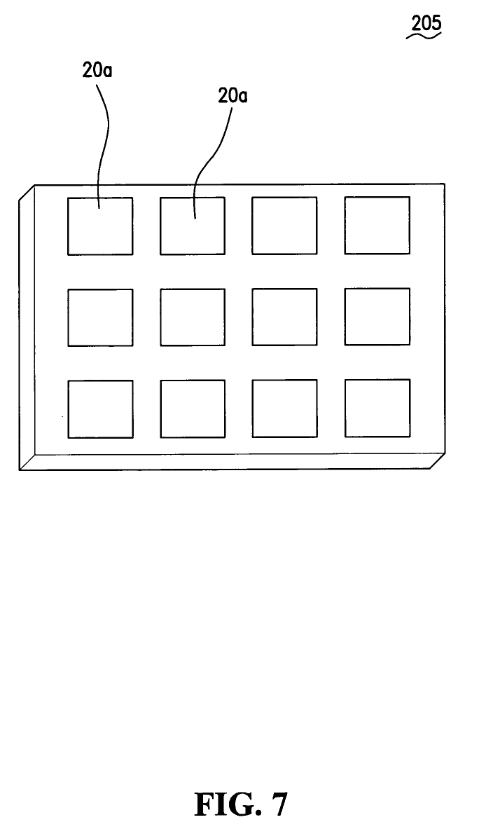

Step 103 is to manufacture the membrane electrode assembly layer 205, referring to FIG. 6 showing the structural decomposition of the membrane electrode assembly layer. The present invention practically implements the means of step 103 is to respectively coat a preset concentration of platinum (Pt) and a preset concentration of Pt/Ru on the proton exchange membrane 205a and polymer material and then utilizes the bonding means to form the membrane electrode assembly layer 205 by the proton exchange membrane 205a, polymer catalyst 205b and carbon paper/carbon cloth 205c. The material of proton exchange membrane 205a is capable of using DuPont Nafion and the coating means is capable of using polyimide printing. The preset concentration coated within the anode active area by using the solvent to formulate catalyst Pt/Ru is between 1 mg/cm² and 10 mg/cm2, and the preset concentration coated within the cathode active area by using the solvent to formulate catalyst Pt is between 1 mg/cm² and 10 mg/cm². Using coating and screen printing to directly print the active catalyst upon the proton exchange membrane 205a or carbon cloth/carbon paper 205c under high temperature of 100° C. to 180° C. about 1 minute to 20 minutes for lamination will compete the manufacture of the membrane electrode assembly layer 205. By way of the manufacturing means of step 103, the membrane electrode assembly layer 205 is capable of including plural fuel cell units 20a, referring to FIG. 7 showing the structural diagram of the membrane electrode assembly layer 205 manufactured by the present invention.

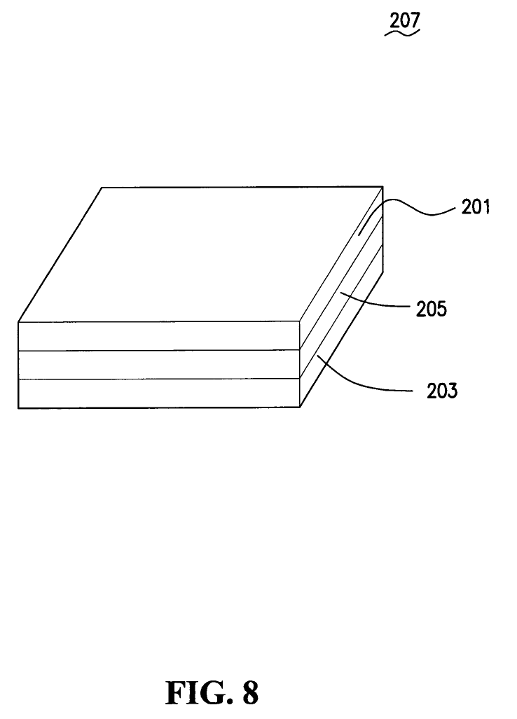

Step 105 uses the process of lamination or bonding by laminating the anode current collection layer 201, membrane electrode assembly layer 205 and cathode current collection layer 203 into the fuel cell reactive layer 207 from top to down. Referring to FIG. 8 showing the structural diagram of the fuel cell reactive layer manufactured by the present invention, the present invention implemented means of the step 105 is able to use bonding medium to laminate the anode current collection layer 201, cathode current collection layer 203 and membrane electrode assembly layer 205 together from top to down by the means of printed or prepreg lamination, meanwhile it is possible to use alignment holes on each layer to proceed precisely aligned lamination, and then utilizes the thermal-pressure machine for lamination to produce the fuel cell reactive layer 207. The operating environment of the thermal-pressure machine in step 105 is to set the temperature of thermal-pressure machine in the range of 80° C. to 200° C. and the pressure in the range of 2 Kg/cm² to 50 Kg/cm² for lamination. The bonding medium used in step 105 is possible to use epoxy or prepreg.

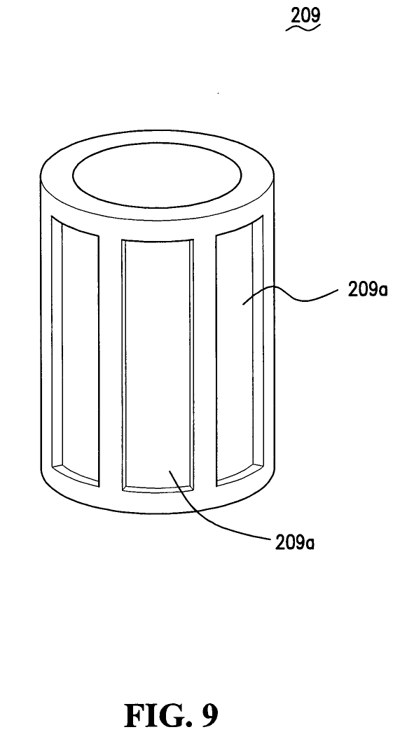

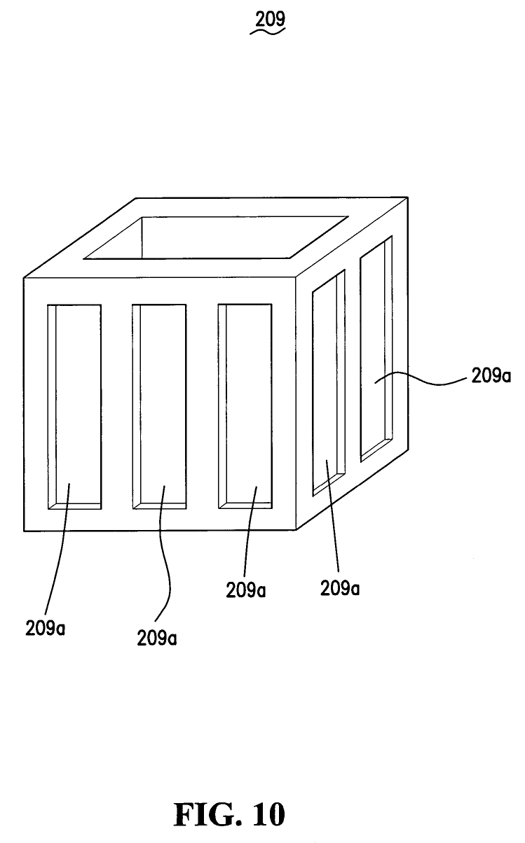

Step 107 uses the flexible substrate to manufacture the flow layer 209. Referring to FIG. 9 showing the structural diagram of the flow layer manufactured by the present invention and FIG. 10 showing the structural diagram of the flow layer in another different view manufactured by the present invention, the flow layer 209 is designed according to the requirements of the geometry and different appearances of the fuel cell 20 in step 107, and then is manufactured based on the designed geometry and appearances. The present invention implementing the means of step 107 is to use thermal-pressure machine, laser machine, CNC machine and utilizes the flexible circuit substrate or non-metallic substrate possibly matching mechanism shape as the embodiment of flexible substrate, and forms the flexible substrate a preset depth of recess which is the flow recess 209a, the flow recess 209a has a preset depth in the range of 1 mm to 10 mm.

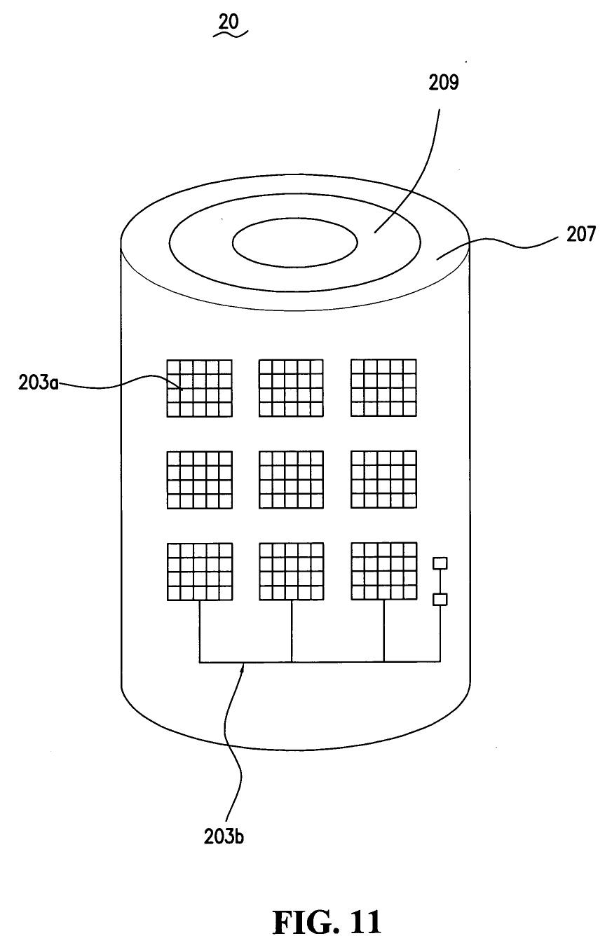

Step 109 bonds the fuel cell reactive layer 207 and flow layer 209, referring to FIG. 11 showing the structural diagram of the flexible substrate laminate integrated fuel cell manufactured by the present invention. The implemented means of the present invention step 109 is to use laminating or bonding process by the means of printing or prepreg lamination by the bonding medium to laminate each fuel cell reactive layer 207 and each flow layer 209, and then proceeds the compression by the thermal-pressure machine or high temperature curing to produce the flexible substrate laminate integrated fuel cell 20. The operating environment of compressing by the thermal-pressure machine or curing is able to set the temperature in the range of 80° C. to 200° C. for compression or curing in step 109. The bonding medium used in step 109 is possible to use epoxy or prepreg.

The present invention manufacturing method 10 and the flexible substrate laminate integrated fuel cell 20 produced thereof has the following advantages and improvements:
1. Integrated manufacturing and material costs are low, further reducing the application product volume and also conforming to the economic effect;
2. According to the requirements of different shape and appearance to easily manufacture conformed fuel cell, it therefore possibly provides versatile battery electricity for electronics;
3. It suits the productivity process and has standardization;
4. It has high flexibility and light, thin, small features to change the shape according to the space limitation;
5. It has erosion-proof, anti-leakage and gas-leak prevention; and
6. It is foldable without influencing the signal conduction.

The present invention, emphasized herein again, utilizes the process of flexible circuit substrate to manufacture the flexible substrate laminate integrated fuel cell, and therefore easily meets the strict requirements of different volume and appearance of the fuel cell system.

Although the present invention has been disclosed by the better embodiment as the above, it does not imply to limit the present invention, any person who is skilled the art could make any change or modification within the spirit and scope of the present invention, however, these change and modification belong to the scope of the present invention defined by the following claims.

What is claimed is:

1. A manufacturing method of flexible substrate laminate integrated fuel cell, comprising the following steps:
(A). a flexible circuit substrate used by the printed circuit board (PCB), utilizing the PCB process, respectively manufactures an anode current collection layer and a cathode current collection layer;
(B). manufacturing a membrane electrode assembly layer;
(C). utilizing the lamination or bonding process to laminate the anode current collection layer, the membrane electrode assembly layer and the cathode current collection layer into a fuel cell reactive layer from top to down;
(D). utilizing a flexible substrate to manufacture a flow layer;
(E). bonding the fuel cell reactive layer and the flow layer;
accordingly, completing the manufacture of the flexible substrate laminate integrated fuel cell.

2. The manufacturing method of flexible substrate laminate integrated fuel cell according to claim 1, wherein the step (A) to manufacture the anode current collection layer is to drill the flexible circuit substrate and then plate the chemical cooper with a thickness of 10 u to 50 u inches on the whole substrate, and plates again the cooper with a thickness of 200 u to 500 u inches to therefore plate the gold with a thickness of 3 u to 10 u inches after film lamination, photo exposure and develop.

3. The manufacturing method of flexible substrate laminate integrated fuel cell according to claim 1, wherein the anode current collection layer includes at least one anode current collection, and wherein each anode current collection corresponds to one fuel cell unit of the membrane electrode assembly layer.

4. The manufacturing method of flexible substrate laminate integrated fuel cell according to claim 1, wherein the anode current collection layer further includes a control circuit.

5. The manufacturing method of flexible substrate laminate integrated fuel cell according to claim 1, wherein the step (A) to manufacture the cathode current collection layer is to drill the flexible circuit substrate and then plate the chemical cooper with a thickness of 10 u to 50 u inches on the whole substrate, and plates again the cooper with a thickness of 200 u to 500 u inches to therefore plate the gold with a thickness of 3 u to 10 u inches after film lamination, photo exposure and develop.

6. The manufacturing method of flexible substrate laminate integrated fuel cell according to claim 1, wherein the cathode current collection layer includes at least one cathode current collection, and wherein each cathode current collection corresponds to one fuel cell unit of the membrane electrode assembly layer.

7. The manufacturing method of flexible substrate laminate integrated fuel cell according to claim 1, wherein the cathode current collection layer further includes a control circuit.

8. The manufacturing method of flexible substrate laminate integrated fuel cell according to claim 1, wherein the step (B) to manufacture the membrane electrode assembly layer is to use lamination means to laminate a proton exchange membrane, a polymer catalyst layer and a carbon paper/carbon cloth to form the membrane electrode assembly layer.

9. The manufacturing method of flexible substrate laminate integrated fuel cell according to claim 8, wherein the proton exchange membrane material is possible to use DuPont Nafion material.

10. The manufacturing method of flexible substrate laminate integrated fuel cell according to claim 1, wherein the step (C) utilizing the printed or prepreg laminating means by the bonding medium laminates in order from the anode current collection layer, the membrane electrode assembly layer and the cathode current collection layer, and therefore proceeds compression by the thermal-pressure machine to produce the fuel cell reactive layer.

11. The manufacturing method of flexible substrate laminate integrated fuel cell according to claim 1, wherein the step (D) utilizes at least one of the thermal-pressure machine, laser machine or CNC machine to form a preset depth and at least above one flow recess on the flexible substrate.

12. The manufacturing method of flexible substrate laminate integrated fuel cell according to claim 11, wherein the preset depth is in the range of 1 mm to 10 mm.

13. The manufacturing method of flexible substrate laminate integrated fuel cell according to claim 11, wherein the flexible substrate is a flexible and non-metallic substrate.

14. The manufacturing method of flexible substrate laminate integrated fuel cell according to claim 11, wherein the flexible substrate is a flexible circuit substrate used as the PCB.

15. The manufacturing method of flexible substrate laminate integrated fuel cell according to claim 1, wherein the step (E) utilizes printing or prepreg lamination means in use of the bonding medium by way of lamination or bonding process to laminate the fuel cell reactive layer and the flow layer together and then proceed compression or high temperature curing by the thermal-pressure machine to produce the flexible substrate laminate integrated fuel cell.

16. The manufacturing method of flexible substrate laminate integrated fuel cell according to claim 15, wherein the thermal-pressure machine operating in compression or curing environment is possible to set the temperature in the range of 80° C. to 200° C. for compression or curing.

17. The manufacturing method of flexible substrate laminate integrated fuel cell according to claim 15, wherein the bonding medium is one of epoxy and prepreg.

18. The manufacturing method of flexible substrate laminate integrated fuel cell according to claim 15, wherein the flexible substrate laminate integrated fuel cell is a flexible substrate laminate integrated direct methanol fuel cell.

19. The manufacturing method of flexible substrate laminate integrated fuel cell according to claim 1, wherein the flexible circuit substrate is a flexible circuit copper foil substrate.

20. A flexible substrate laminate integrated fuel cell, comprising:
a fuel cell reactive layer, comprising:
an anode current collection layer, manufactured by a flexible circuit substrate used in the PCB;
a cathode current collection layer, manufactured by a flexible circuit substrate used in the PCB;
a membrane electrode assembly layer, utilizing lamination or bonding process to be closely sandwiched between the anode current collection layer and the cathode current collection layer;
a flow layer manufactured by a flexible substrate, utilizing printing or prepreg lamination means in use of bonding medium to laminate with the fuel cell reactive layer and then proceeding compression or high temperature curing for the laminated fuel cell reactive layer and flow layer by the thermal-pressure machine.

21. The flexible substrate laminate integrated fuel cell according to claim 20, wherein the flow layer includes at least one flow recess and utilizes one of thermal-pressure machine, laser machine and CNC machine to form a preset depth of the flow recess on the flexible substrate.

22. The flexible substrate laminate integrated fuel cell according to claim 21, wherein the preset depth of the flow recess is in the range of 1 mm to 10 mm.

23. The flexible substrate laminate integrated fuel cell according to claim 20, wherein the flexible circuit substrate is a flexible circuit copper foil substrate.

24. The flexible substrate laminate integrated fuel cell according to claim 20, wherein the flexible substrate is a flexible and non-metallic substrate.

25. The flexible substrate laminate integrated fuel cell according to claim 20, wherein the flexible substrate is a flexible circuit substrate used in the PCB.

26. The flexible substrate laminate integrated fuel cell according to claim 20, wherein the flexible substrate laminate integrated fuel cell is a flexible substrate laminate integrated direct methanol fuel cell.

27. The flexible substrate laminate integrated fuel cell according to claim 20, wherein the anode current collection layer includes at least one anode current collection, and wherein each anode current collection corresponds to one fuel cell unit of the membrane electrode assembly layer.

28. The flexible substrate laminate integrated fuel cell according to claim 27, wherein the anode current collection layer further includes a control circuit.

29. The flexible substrate laminate integrated fuel cell according to claim 20, wherein the cathode current collection layer includes at least one cathode current collection, and wherein each cathode current collection corresponds to one fuel cell unit of the membrane electrode assembly layer.

30. The flexible substrate laminate integrated fuel cell according to claim 29, wherein the cathode current collection layer further includes a control circuit.

31. The flexible substrate laminate integrated fuel cell according to claim 20, wherein the flexible circuit substrate is a flexible circuit copper foil substrate.
